(19) United States
(12) Patent Application Publication
(10) Pub. No.: US 2009/0290792 A1
(43) Pub. Date: Nov. 26, 2009

(54) METHOD FOR SETTING AUTO WHITE BALANCE AREA

(76) Inventor: SUNG HO SON, Gwangmycong-si (KR)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/432,379

(22) Filed: Apr. 29, 2009

(30) Foreign Application Priority Data
May 21, 2008 (KR) 10-2008-0047064

(51) Int. Cl. G06K 9/00

(52) U.S. Cl. 382/167; 382/263; 382/264

(57) ABSTRACT

Disclosed is a method for setting an auto white balance area. An image is received from an image sensor. An edge from the image is detected and an edge area having no color information is removed from the image. The image, from which the edge area is removed, is divided into blocks having preset sizes. Remaining areas are set as an auto white balance area except a darkest area and a brightest area by applying a threshold value for brightness to the divided image.

### CROSS-REFERENCE TO RELATED APPLICATION

The present application claims the benefit under 35 U.S.C. § 119 of Korean Patent Application No. 10-2008-0047064, filed May 21, 2008, which is hereby incorporated by reference in its entirety.

### FIELD OF THE INVENTION

The embodiment relates to a method for setting an auto white balance area.

### BACKGROUND

Auto white balance is to compensate for color distortion of an image caused by light sources. The auto white balance is adopted to express a color of an object without color distortion when light having a predetermined color is input into an image sensor after the light has been reflected variously according to the light sources.

In other words, when light from the sun, a fluorescent lamp, or a glow lamp are irradiated onto a white paper, the light represents a natural color, a blue color, and a red color, respectively, due to the characteristic of a spectral distribution curve of the light.

In this case, although a human can recognize colors by correcting color difference made by various light sources, when an object is photographed by using an image sensor, the image sensor receives the colors expressed by various light sources without correcting the color difference. Accordingly, the colors are expressed with different color temperatures.

Therefore, the intensity of color components of red (R), green (G), and blue (B) signal components, which are input into the image sensor, must be automatically adjusted approximately to color information of an object, which is called auto white balance.

In a method for setting an auto white balance area, the whole area of a screen image or an area specified from the screen image by a user is set as a target area for auto white balance.

If one color is excessively distributed on a screen image, a complementary color may be strongly applied for the purpose of auto white balance, causing, a monochromatic tracking error.

### BRIEF SUMMARY

Embodiments relate to a method for setting an auto white balance area of an image.

According to embodiments, a method for setting an auto white balance area includes receiving an image from an image sensor; detecting an edge from the image and removing an edge area having no color information from the image; dividing the image, from which the edge area is removed, into blocks having preset sizes; and setting remaining areas as an auto white balance area except a darkest area and a brightest area by applying a threshold value for brightness to the divided image.

According to embodiments, a method for setting auto white balance includes receiving an image from an image sensor; removing an edge area having no color information from the image and detecting an edge from the image; dividing the image, from which the edge area is detected, into blocks having preset sizes; and setting remaining areas as an auto white balance area except a darkest area and a brightest area by applying a threshold value for brightness to the divided image.

### BRIEF DESCRIPTION OF THE DRAWINGS

FIG. 1 is a flowchart showing a method for setting an auto white balance area according to a first embodiment;

FIGS. 2A to 2D are views showing the processes for setting an auto white balance area according to the first embodiment;

FIG. 3 is a flowchart showing a method for setting an auto white balance area according to a second embodiment; and

FIGS. 4A to 4D are views showing the processes for setting an auto white balance area according to the second embodiment.

### DETAILED DESCRIPTION

Hereinafter, a method for setting an auto white balance area according to embodiments will be described with respect to accompanying drawings.

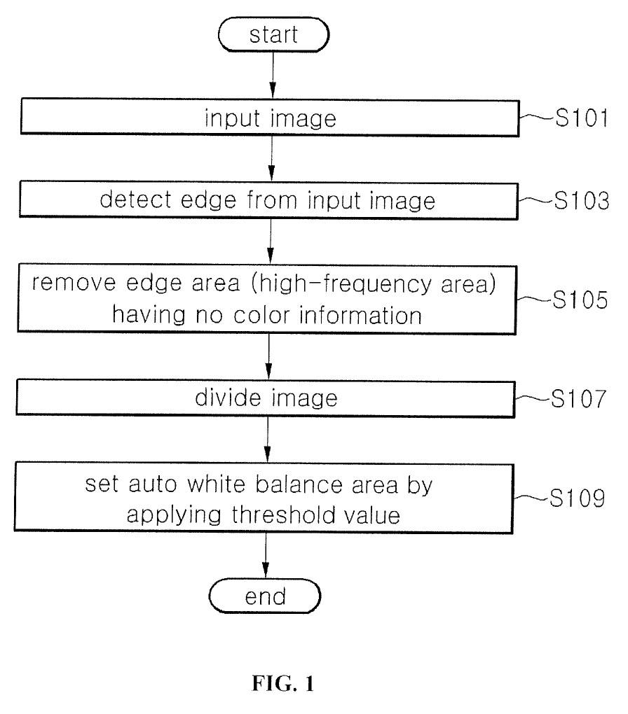

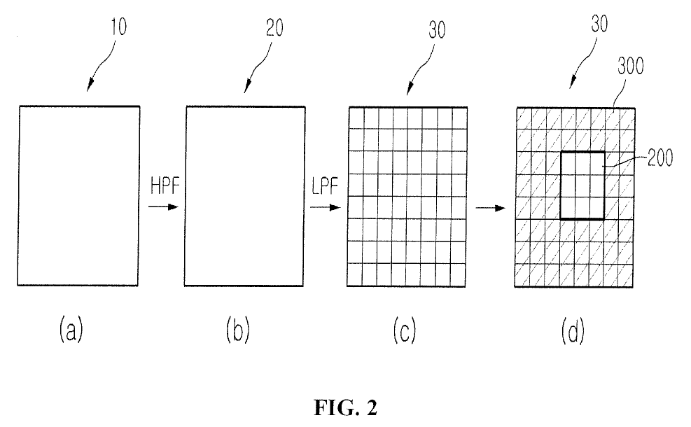

FIG. 1 is a flowchart showing a method for setting an auto white balance area according to a first embodiment, and FIGS. 2A to 2D are views showing the processes for setting the auto white balance area according to the first embodiment.

As shown in FIGS. 1 to 2D, a first image 10, which has been photographed, is input as an electric signal by an image sensor (Step S101).

The first image 10 may be taken by a digital camera, a video camera, or a camera of a portable phone.

Then, after extracting a brightness area Y from the first image 10, a high pass filter is applied to the first image 10 to enhance the edge of the first image 10 (Step S103).

When the high pass filter is applied to the first image 10, the first image 10 can be more cleared due to the enhancement of the edge thereof.

Next, a low pass filter is applied to a second image 20 having an enhanced edge to remove an edge area having no color information (Step S105).

The edge area having no color information may be a high-frequency area representing an image of a hair or grassland.

The high-frequency area is removed, so that the second image 20 having the enhanced edge can be more blurred.

Thereafter, an image, from which the edge area having no color information is removed, is divided into blocks having preset sizes (Step S1.07).

In this case, the image may be divided into 8×8, 16×16, 32×32, or 64×64 blocks.

Subsequently, a threshold value for brightness is applied to the image 30 that has been subject to the above division, so that remaining areas are set as an auto white balance area 200 except the darkest area and the brightest area (Step S109).

In this case, the darkest area may have a brightness level of about 0 to about 20, mid the brightest area may have a brightness level of about 240 to about 255.

However, the threshold value may be adjusted without being limited to the above values.

Thereafter, white balance may be calibrated by adjusting gains of red (R) and blue (B) signals among image signals of the auto white balance area 200.

In this case, a gain of a G (green) signal among the image signals may be fixed, and the gains of the R and B signals may be adjusted corresponding to the fixed gain of the G signal, thereby calibrating white balance.

In addition, the gains of the R and B signals, which have been applied to the auto white balance area 200, are applicable to an adjacent area 300 at the same ratio.

In other words, when the white balance is calibrated with respect to the auto white balance area 200, the gain adjustment ratio between the R and B signals is applied to the adjacent area 300.

Accordingly, when auto white balance is carried out with respect to an image having the excessive distribution of one color, a monochromatic tracking error may be inhibited.

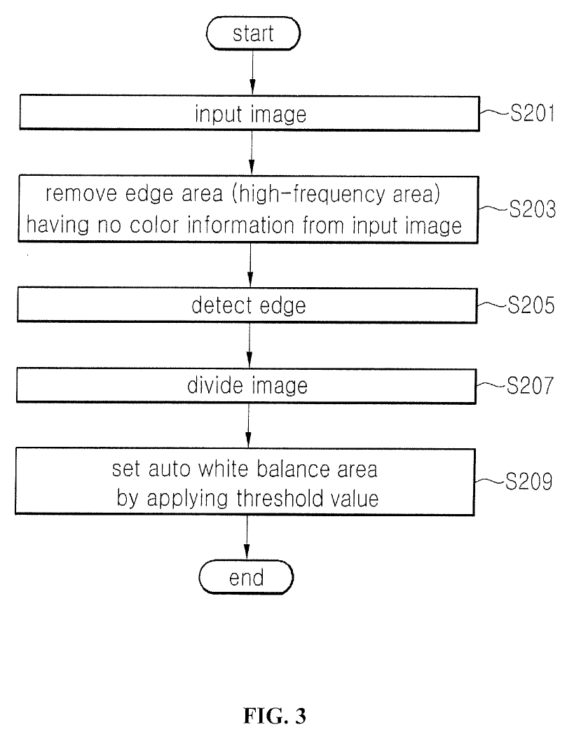

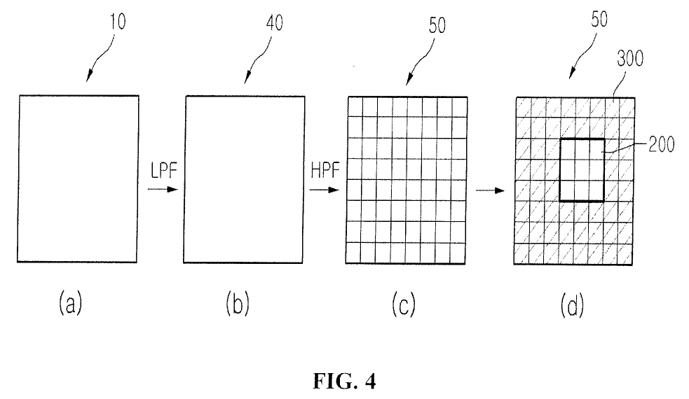

FIG. 3 is a flowchart showing a method for setting an auto white balance area according to a second embodiment, and FIGS. 4A to 4D are views showing the processes for setting the auto white balance area according to the second embodiment.

As shown in FIGS. 3 to 4D, the first image 10, which has been photographed, is input as an electric signal by an image sensor (Step S201).

The first image 10 may be taken by a digital camera, a video camera, or a camera of a portable phone.

Then, after extracting a brightness area Y from the first image 10, a low pass filter is applied to the first image 10 to remove an edge area having no color information (Step S203).

The edge area having no color information may be a high-frequency area representing an image of a hair or grassland.

The high-frequency area is removed so that the first image 10 can be more blurred.

Subsequently, a high pass filter is applied to a second image 40, which has been subject to the low pass filter, thereby enhancing an edge of the second image 40 (Step S205).

If the high pass filter is applied to the second image 40, which has been subject to the low pass filter, the edge of the second image 40 can be enhanced to clear the second image 40.

Subsequently, an image, from which an edge area is removed, is divided into blocks having preset sizes (Step S207).

In this case, the image may be divided into 8×8, 16×16, 32×32, or 64×64 blocks.

Subsequently, a threshold value for brightness is applied to an image 50 that has been subject to the division, so that remaining areas are set as an auto white balance area 200 except the darkest area and the brightest area (Step S209).

In this case, the darkest area has a brightness level of about 0 to about 20, and the brightest area has a brightness level of about 240 to about 255.

However, the threshold value can be adjusted without being limited to the above values.

Thereafter, white balance can be calibrated by adjusting gains of red (R) and blue (B) signals among image signals of the auto white balance area 200.

In this case, a gain of a G (green) signal among the image signals may be fixed, and the gains of the R and B signals are adjusted corresponding to the fixed gain of the G signal, thereby calibrating white balance.

In addition, the gains of the R and B signals, which have been applied to the auto white balance area 200, are applicable to an adjacent area 300 at the same ratio.

In other words, when the white balance is calibrated with respect to the auto white balance area 200, a gain adjustment ratio between the R and B signals is applied to the adjacent area 300.

Accordingly, when auto white balance is carried out with respect to an image having the excessive distribution of one color, a monochromatic tracking error may be inhibited.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview ozone skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit Hid scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for setting an auto white balance area, the method comprising:
receiving an image from an image sensor;
detecting an edge from the image and removing an edge area having no color information from the image;
dividing the image, firm which the edge area is removed, into blocks having preset sizes; and
setting remaining areas as an auto white balance area except a darkest area and a brightest area by applying a threshold value for brightness to the divided image.

2. The method of claim 1 wherein, after receiving the image from the image sensor, a brightness area is extracted from the image.

3. The method of claim 1, wherein the detecting of the edge from the image and removing of the edge area having no color information from the image comprises:
applying a high pass filter to the image to enhance the edge; and
applying a low pass filter for the image having the enhanced edge to remove the edge area having no color information.

4. The method of claim 1, wherein, in the dividing of the image, from which the edge area is removed, into the blocks having the preset sizes, the image is divided into one of 8×8, 16×16, 32×32, and 64×64 blocks.

5. The method of claim 1, wherein, in the setting of the remaining areas as the auto white balance area except the darkest area and the brightest area, the darkest area has a brightness level of about 0 to about 20.

6. The method of claim 1, wherein, in the setting of the remaining areas as the auto white balance area except the darkest area and the brightest area, the brightest area has a brightness level of about 240 to about 255.

7. The method of claim 1, further comprising calibrating white balance by adjusting gains of red and blue signals of image signals with respect to the auto white balance area, after setting the auto white balance area.

8. The method of claim 7, wherein, when the white balance is calibrated, a gain of a green signal of the image signals is fixed.

9. The method of claim 7, wherein the gains of the red and blue signals, which have been applied to the auto white balance area, are applied to an area adjacent the auto white balance area at an identical ratio.

10. The method of claim 1, wherein the edge area having no color information is a high-frequency area.

11. A method for setting auto white balance, the method comprising:
receiving an image from an image sensor;
removing an edge area having no color information from the image and detecting an edge from the image;
dividing the image, from which the edge area is detected, into blocks having preset sizes; and
setting remaining areas as an auto white balance area except a darkest area and a brightest area by applying a threshold value for brightness to the divided image.

12. The method of claim 11, wherein, after receiving the image from the image sensor, a brightness area is extracted from the image.

13. The method of claim 11, wherein the removing of the edge area having no color information from the image and the detecting of the edge from the image comprise:
applying a low pass filter to the image to remove the edge area having no color information; and
applying a high pass filter for the image, from which the edge area having no color information has been removed, to enhance the edge of the image.

14. The method of claim 11, wherein, in the dividing of the image into the blocks having the preset sizes, the image is divided into one of 8×8, 16×16, 32×32, and 64×64 blocks.

15. The method of claim 11, wherein, in the setting of the remaining areas as the auto white balance area except the darkest area and the brightest area, the darkest area has a brightness level of about 0 to about 20.

16. The method of claim 11, wherein, in the setting of the remaining areas as the auto white balance area except the darkest area and the brightest area, the brightest area has a brightness level of about 240 to about 255.

17. The method of claim 11, further comprising calibrating white balance by adjusting gains of red and blue signals of image signals with respect to the auto white balance area, after setting the auto white balance area.

18. The method of claim 17, wherein, when the white balance is calibrated, a gain of a green signal of the image signals is fixed.

19. The method of claim 17, wherein the gains of the red and blue signals, which have been applied to the auto white balance area, are applied to an area adjacent the auto white balance area at an identical ratio.

20. The method of claim 1, wherein the edge area having no color information is a high-frequency area.
